(19) United States
(12) Patent Application Publication
(10) Pub. No.: US 2014/0370327 A1
(43) Pub. Date: Dec. 18, 2014

(54) HIGH VACUUM COMPONENTS

(71) Applicant: Martin Richard Ingles, Coventry (GB)

(72) Inventor: Martin Richard Ingles, Coventry (GB)

(73) Assignee: GE Energy Power Conversion Technology Ltd., Warwickshire (GB)

(21) Appl. No.: 13/993,872

(22) PCT Filed: Dec. 8, 2011
(86) PCT No.: PCT/EP2011/072192

§ 371 Date: Jul. 16, 2013

(30) Foreign Application Priority Data
Dec. 14, 2010 (GB) 1021136.5

(51) Int. Cl. F16J 12/00

(52) U.S. Cl. CPC F16J 12/00
USPC 428/626; 428/457; 428/426; 428/408; 428/36.4

(57) ABSTRACT

A high vacuum component, e.g. a vacuum chamber wall or a component that is operated or positioned within a vacuum chamber in use is described. The component is substantially formed of a layered material comprising a fibrous composite material layer having a surface that is coated with a copper intermediate layer and an impermeable outer layer of nickel. In use the outer layer is exposed to a high vacuum.

### TECHNICAL FIELD

The present invention relates to components designed to be used in very low pressure environments i.e. high vacuums. In particular, the present invention provides components that are formed of a new layered material that is particularly suitable for exposure to a high vacuum.

### BACKGROUND ART

In many apparatus it is necessary for certain components to be used in very low pressure environments i.e. a high vacuum. For example, in order to operate properly, many superconducting electrical machines require at least a part of the machine to be maintained in a cryogenic temperature range. In order to maintain components within a cryogenic temperature range it is necessary to thermally insulate those components from the warmer surrounding environment. One way of doing this is to locate the cryogenic components within a very low pressure environment, which is normally contained within a vacuum chamber. Vacuum chambers for components maintained within a cryogenic temperature range typically operate at a pressure somewhere between 0.01 Pa and 1×10⁻⁹ Pa, and most preferably at a pressure between 1×10⁻⁵ Pa and 1×10⁻⁹ Pa. Components that must be able to operate satisfactorily in this pressure range include the walls of the vacuum chamber as well as components completely located within the vacuum chamber.

Generally, the materials from which these components are made must fulfil a number of criteria. They must be capable of being machined and fabricated. They must also have adequate strength. The vapour pressure of the material must remain sufficiently low at the highest operating temperature. The material must have a suitable coefficient of thermal expansion that allows it to be securely connected to adjacent materials especially at joints that must be vacuum-tight. The material must not be porous and must be free of cracks and/or crevices that could trap cleaning solvents.

Additionally, surface and bulk desorption rates must be acceptable in the known operating conditions.

Currently, due to the above requirements, most components for forming or locating within a vacuum chamber are made of stainless steel or aluminium. These materials have the required structural properties and do not emit significant amounts of gas when located within a very low pressure environment. However, these materials have a specific strength that is relatively low and, as a result, components formed of these materials are relatively heavy. In many applications it is desirable to minimise the mass of components. However, as is readily understood by the skilled person, lighter structural materials such as fibrous composite materials and plastics can not generally be used for components for forming or locating within a vacuum chamber as they do not fulfil all of the requirements set out above.

Accordingly, there is a need for new components for operating in high vacuums that are formed of a material that has a higher specific strength than stainless steel or aluminium and that meets all of the requirements or criteria set out above.

### SUMMARY OF THE INVENTION

The present invention provides a high vacuum component substantially formed of a layered material comprising a fibrous composite material layer and an impermeable metal outer layer, wherein in use the outer layer is exposed to a high vacuum.

A high vacuum component according to the present invention is any component that has at least one surface (typically the surface of the outer layer) that is exposed to a high vacuum in use. This includes a wall of a high vacuum chamber and any component that is positioned or located within such a chamber, for example. Furthermore it is to be understood that a high vacuum component according to the present invention may itself form part of a larger component or apparatus. For example, a barrier wall of an apparatus that is exposed to a high vacuum can be a component according to the present invention and can be formed of the layered material described above. If only a portion of the larger component or apparatus is exposed to a high vacuum in use then that portion can be formed of the layered material while the remainder of the larger component or apparatus can be formed in a conventional manner using conventional materials.

In relation to the present invention a high vacuum is any vacuum that has a maximum pressure of 0.01 Pa or less, and more preferably a vacuum that has a maximum pressure of 1×10⁻⁵ Pa or less.

The layered material from which components according to the present invention are substantially formed is advantageous as it is suitable for exposure to a high vacuum and may have a specific strength that is better than conventional materials that are also suitable for use in such environments. The layered material is a composite material and, as such, utilises the benefits of a plurality of separate materials to provide a composite material that has properties that are superior to any of those separate materials taken in isolation. In particular, coating the fibrous composite material with an impermeable metal layer allows the coated surface of the fibrous composite material to be exposed to a high vacuum.

The fibrous composite material of the present invention may be a glass fibre or carbon fibre based material. However, it will be readily understood that the fibrous composite material may comprise any suitable fibrous composite material with the required material properties. It is to be noted that components formed purely of fibrous composite materials can not be used in high vacuums. This is because they have a relatively high permeability and the resins that are used in their manufacture will outgas in a high vacuum, thereby depleting the vacuum. Furthermore, fibrous composites coated with plastics or permeable metal layers also can not be used in a high vacuum for the same reasons.

In some embodiments of the present invention the impermeable metal outer layer may be directly coated onto or formed on a surface of the fibrous composite material layer. However, in preferred embodiments of the invention the layered material will further comprise an intermediate layer directly coated onto or formed on a surface of the fibrous composite material layer. The outer layer is then directly coated onto or formed on an outer surface of the intermediate layer.

The intermediate layer may be formed of any suitable material. However, it is advantageous that the intermediate layer is formed of copper or a similar material. Forming the intermediate layer of copper is advantageous because it is a material that may be easily deposited on a surface of fibrous composite material. An intermediate layer of copper can be deposited on the fibrous composite material by plasma spraying, sputtering or any other suitable method that is known to a person skilled in the art. It is also advantageous to use copper or a similar material as an intermediate layer because it is a material that is unlikely to degrade or corrode during manufacture. This is important as corrosion or degradation during manufacture can cause a material to absorb water or other substances that may be subsequently be outgassed when the component is exposed to a high vacuum. Although copper and other similar materials are suitable for use as the intermediate layer they are not considered to be readily suitable for use as the outer layer because conventional methods for depositing copper on a fibrous composite material do not generally produce an impermeable layer.

As will be readily appreciated, the presence of an intermediate layer (preferably formed of copper or a similar material) is advantageous as it provides a reliable and suitable surface onto which the impermeable metal outer layer may be deposited. Due to the possible methods of deposition used for depositing the intermediate layer and the outer layer, it is generally necessary to deposit the intermediate layer on the fibrous composite material before the outer layer is deposited on the intermediate layer.

The outer layer may be formed of any suitable metal. It may be preferable that the outer layer is formed of nickel. The outer layer may be deposited on the fibrous composite layer or the intermediate layer in any manner that is apparent to the person skilled in the art. If the outer layer is formed of nickel it may be preferable that the nickel is deposited by means of electroless plating. However, nickel may be deposited using any other suitable method.

The layered material can be formed such that one or more surfaces of the material are coated with an impermeable metal outer layer. For example, if the component is a flat sheet then one or both sides can be coated with an outer layer as required by the operation of the component, such coating being optionally applied to an underlying intermediate layer. A component according to the present invention will typically have all the surfaces that are exposed to a high vacuum in use coated with an impermeable metal outer layer. Surfaces of a component that are not exposed to a high vacuum during operation need not be coated.

Further features and advantages of the present invention will be apparent from the preferred embodiment which is shown in FIG. 1 and discussed below.

### DRAWINGS

FIG. 1 is a schematic cross-section of a section of preferred embodiment of a component according to the present invention.

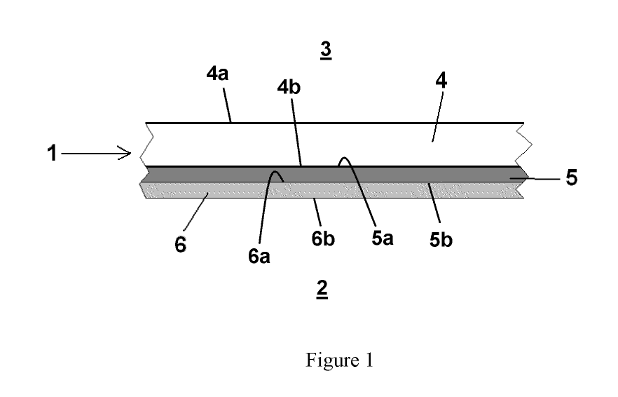

A schematic cross-section of a preferred embodiment of part of a component 1 according to the present invention is shown in FIG. 1. The component 1 shown in FIG. 1 is a wall of a vacuum chamber. The vacuum chamber wall encloses a vacuum region 2 that is maintained at a high vacuum. An exterior region 3 surrounds the vacuum chamber and is at a substantially normal environmental pressure.

The component 1 is formed of a layered material consisting of three layers. The component 1 comprises a structural base layer 4 that is formed of a glass fibre composite material. A first side 4a of the base layer 4 is exposed to the exterior region 3.

An intermediate layer 5 of copper is formed on a second side 4b of the base layer 4. A first side 5a of the intermediate layer 5 is adjacent the second side 4b of the base layer 4 and forms an interface therewith.

An impermeable outer layer 6 of nickel is formed on a second side 5b of the intermediate layer 5. A first side 6a of the outer layer 6 is adjacent the second side 5b of the intermediate layer 5 and forms an interface therewith. A second side 6b of the outer layer 6 is exposed to the vacuum region 2.

The component 1 is formed in the following manner. The intermediate layer 5 is deposited on the second side 4b of the base layer 4 by means of plasma spraying. After this has been done the outer layer 6 is deposited on the second side 5b of the intermediate layer 5 by electroless plating. In an alternative embodiment, the outer layer can be deposited directly on the base layer and no intermediate layer is needed.

The outer layer 6 of the component 1 is exposed to the vacuum region 2 and will not emit significant amounts of gas when exposed to a high vacuum. Additionally, the outer layer 6 is impermeable and does not allow outgassing from either the base layer 4 or the intermediate layer 5. As a result of the properties of the outer layer 6, the component 1 can form an effective barrier around the vacuum region 2 and minimal action is needed to maintain the high vacuum within the vacuum region 2.

The base layer 4 comprises the bulk of the component 1 and provides structural strength. Because the base layer 4 is formed of lightweight but strong glass fibre composite material then it will be readily appreciated that the specific strength of the component 1 is relatively high. Furthermore, the use of glass fibre means that the base layer 4 can be formed such that its strength is anisotropic. This allows the component 1 to be formed to specifically resist the forces it will be subjected to during its use.

In the preferred embodiment, the purpose of the intermediate layer 5 is to allow the outer layer 6 to be deposited on the material. It is not currently possible to deposit nickel directly onto glass fibre in a cheap and reliable manner such that an impermeable layer of nickel is formed. However, it is possible to plasma spray copper onto glass fibre to form a layer of copper and it is possible to plate copper with nickel using an electroless process to produce an impermeable layer of nickel. It will be understood that the intermediate layer 5 cannot act as an impermeable barrier because plasma sprayed copper is porous and that this necessitates the outer layer 6. In an alternative embodiment then other materials and/or other deposition processes can be used so that an impermeable metal layer can be applied directly to fibre glass or other fibrous composite material.

It is to be understood that FIG. 1 is only a schematic drawing and that the relative thicknesses of the various layers of the component 1 are not accurately shown. In practice, the relative thicknesses of the layers would differ from those shown in FIG. 1. For example, the base layer 4 will typically be thicker than is shown in FIG. 1 in order to provide the required strength to the component 1. As the specific strength of the intermediate layer 5 and the outer layer 6 is less than that of the base layer 4, the thickness of these layers will be minimised to that which allows them to fulfil their purpose. In particular, the thickness of the intermediate layer 5 will typically be the minimum thickness which allows it to adhere to and cover the second side of the base layer 4 and which allows the outer layer 6 to adhere to and cover the second side of the intermediate layer 5. The thickness of the outer layer 6 will typically be the minimum thickness that allows the outer layer to form an impermeable barrier over the base layer 4 and the intermediate layer 5.

What is claimed is:

1. A high vacuum component substantially formed of a layered material comprising a fibrous composite material layer and an impermeable metal outer layer, wherein in use the outer layer is exposed to a high vacuum.

2. The high vacuum component of claim 1, wherein the outer layer is directly formed on a surface of the fibrous composite material layer.

3. The high vacuum component of claim 1, further comprising a intermediate layer directly formed on a surface of the fibrous composite material layer, and wherein the outer layer is directly formed on an outer surface of the intermediate layer.

4. The high vacuum component of claim 3, wherein the intermediate layer is deposited on the surface of the fibrous composite material layer by plasma spraying.

5. The high vacuum component of claim 3, wherein the intermediate layer is deposited on the surface of the fibrous composite material layer by sputtering.

6. The high vacuum component of claim 3, wherein the outer layer is deposited on the intermediate layer by electroplating.

7. The high vacuum component of claim 3, wherein the outer layer is deposited on the intermediate layer by electroless plating.

8. The high vacuum component of claim 3, wherein the intermediate layer is formed of copper.

9. The high vacuum component of claim 1, wherein the fibrous composite material layer is a glass fibre material.

10. The high vacuum component of claim 1, wherein the fibrous composite material layer is carbon fibre material.

11. The high vacuum component of claim 1, wherein the outer layer is formed of nickel.

12. The high vacuum component of claim 1, wherein opposing surfaces of the fibrous composite material layer are coated with an impermeable metal outer layer, and wherein in use both outer layers are exposed to a high vacuum.

13. The high vacuum component of claim 1, wherein opposing surfaces of the fibrous composite material layer are coated with an intermediate layer, each intermediate layer is coated with an impermeable metal outer layer, and wherein in use both outer layers are exposed to a high vacuum.

14. The high vacuum component of claim 1, being a vacuum chamber or a part thereof.

15. The high vacuum component of claim 1, being positioned or located within a vacuum chamber in use.
